(19) United States
(12) Patent Application Publication
(10) Pub. No.: US 2021/0284343 A1
(43) Pub. Date: Sep. 16, 2021

(54) GERM PROTECTION SYSTEM FOR VEHICLES, HOSPITALS, RESTAURANTS, SCHOOLS, NURSING HOMES, LIFTS AND THE LIKE

(71) Applicant: MANUEL MUNOZ SAIZ, ALMERIA (ES)

(72) Inventor: MANUEL MUNOZ SAIZ, ALMERIA (ES)

(21) Appl. No.: 17/192,336

(22) Filed: Mar. 4, 2021

(30) Foreign Application Priority Data
Mar. 16, 2020 (ES) P202000080
Jun. 3, 2020 (ES) U202000257
Jun. 8, 2020 (ES) U202000269
Jun. 25, 2020 (ES) U202000313

(51) Int. Cl. B64D 13/06; B60H 3/06; B60H 3/00; F24F 3/16; F24F 8/22

(52) U.S. Cl. CPC B64D 13/06; B60H 3/0608; B60H 3/0071; B64D 2013/0688; F24F 8/22; B64D 2013/0651; F24F 3/16

(57) ABSTRACT

The germ protection system for vehicles, hospitals, restaurants, schools, nursing homes, lifts and the like uses: a) A system that prevents germs: bacteria, protozoa, viruses or parasites from being breathed in vehicles or closed premises, lifts or the like, blowing or sucking air, b) An independent air installation that applies air conditioning, fed with turbofan engines, to the individual air blowing nozzles in the ceiling or backrest of the compartments of each passenger, c) An independent air installation using compressors that extracts and compresses the outside air, and apply it to the individual air blowing nozzles in the ceiling or backrest of the compartments of each passenger, d) A system that uses an individual installation to replace oxygen system in case of emergency, e) A system that is valid simultaneously for protection against germs and for breathing in case of emergency. The air is filtered, disinfected, its pressure, temperature and humidity regulated, and through some ducts it is applied to the masks, helmets, hoods, their ducts or nasal cannulas. f), A system that is coupled to the individual air supply nozzle of the passengers, using for this purpose at the end of the duct of the mask, face mask screen, diving suit or helmet.

### INDEX TO RELATED APPLICATIONS

This application claims the benefit of Spanish application No. P202000080 filed Mar. 16, 2020, Spanish application No. 0202000257 filed Jun. 3, 2020, Spanish application No. U202000269 filed Jun. 8, 2020, and Spanish application No. 0202000313 filed Jun. 25, 2020, the disclosures of which are incorporated herein by reference in their entirety.

### FIELD OF THE INVENTION

In systems for preventing infection by germs in aircrafts, trains, buses, ships hospitals, nursing homes, restaurants, schools, lifts and breathing systems using air during emergencies

### STATE OF THE ART

Vehicles, hospitals, restaurants, schools and the like, lack good protection against germs. The masks in addition to being expensive are not effective, they partially filter, they do not protect the wearer or those around them. This is very important when there are epidemics, since it is difficult to isolate the public, generally due to lack of space. Neither is a correct air renewal carried out. Aircrafts use the dangerous oxygen for breathing in case of emergency, depressurization, etc. Oxygen transported in cylinders or chemically generated is currently used. With the present invention air is used, both for normal breathing and in case of emergency instead of oxygen. The present invention prevents contagion and/or destroys all kinds of germs.

### DESCRIPTION OF THE INVENTION

Objective pursued with the present product and its advantages.

Provides a system that: Is simple, inexpensive, and useful that prevents or destroys viruses, bacteria and protozoa or parasites.

Make the sick independent in hospitals and vehicles, using an independent fresh air circuit:

Avoids the use of oxygen and therefore its danger.

It allows the use of fresh air individually and substitutes oxygen in emergency. It can be used even in case of smoke or fire, which is not possible at present with oxygen.

It can increase a little the pressure and the quantity of oxygen applied as the air is cleaner. It has more oxygen than the recycled air. The applied air can carry more moisture without damaging the aircraft's structure. Fresh air applied is cheaper because the amount is smaller It is not affected by the exhaled air that carries microbes, CO2, ethanol and aldehydes. It is very important to avoid viruses on airplanes, due to its high expansion speed it can contaminate many cities and very quickly.

### CURRENT PROBLEM

In vehicles and other closed places, even open ones with a lot of staff, it is very difficult to avoid the spread or contagion of diseases. Being forced to keep distances that make them unprofitable. The masks are not effective, they partially filter, they do not protect the wearer or those around them. As an example, FFP-2 and FFP3 with valve, if the wearer is infected he exhales and the microbes are not filtered out during exhalation. Not being able to travel causes a great economic deterioration. On the other hand, bad smells among passengers are avoided. In aircrafts, cabin air and oxygen are used in the event of an emergency, but cannot be used with cabin smoke. There is no protection for passengers in adjacent seats. Being heavier than with the air system, and more dangerous especially if the oxygen generators are used.

The germ protection system for vehicles, hospitals, restaurants, schools, nursing homes, lifts and the like uses:

a) A system that prevents germs: bacteria, protozoa, viruses or parasites from being breathed in vehicles or closed premises, lifts or the like, blowing or sucking air,
b) An independent air installation that applies air conditioning, fed with turbofan engines, to the individual air blowing nozzles in the ceiling or backrest of the compartments of each passenger,
c) An independent air installation using compressors that extracts and compresses the outside air, and apply it to the individual air blowing nozzles in the ceiling or backrest of the compartments of each passenger,
d) A system that uses an individual installation to replace oxygen system in case of emergency,
e) A system that is valid simultaneously for protection against germs and for breathing in case of emergency. The air is filtered, disinfected, its pressure, temperature and humidity regulated, and through some ducts it is applied in these compartments, the masks, helmets, hoods, their ducts or nasal cannulas are stored, which are directly connected to the air installation, or carries mouthpieces, fittings, quick connector, nozzles sockets, where the ends of the ducts of the masks or portable cannulas are attached and
f), A system that is coupled to the individual air supply nozzle of the passengers, using for this purpose at the end of the duct of the mask, face mask screen, diving suit or helmet, a hood with at least one semi-annular, semi-thorax or semi-oval suction cup which, when pressed, adapts and attaches to the chassis or panel carrying the air supply nozzles (48) of the air conditioning system of the aircraft or vehicle.

In vehicles and especially in aircrafts, air is blown in from the air conditioning, in the seat area where the passenger inhales. The air can come from gas turbines, the system of most current aircrafts, or from some compressors that get it from the outside of the aircraft or vehicles, thus avoiding contamination of the air conditioning by oil leaks from the engines or turbines.

In vehicles and especially in aircrafts, the passenger can be blown or sucked in air by: 1) grooves in the area of the seat close to the head, 2) rotating or flexible hollow arm-jets, or 3) masks and some ducts. You can also create an area or space around the head, where the air is blown or sucked, an area that can be formed or obtained and surround with: a) a flared cover, b) a cap that is fastened simultaneously covering the backrest and part of the area of the head, c) a cap that rotates and extends partially covering the head, d) a cap with protruding side flaps that simultaneously carry grooves through which air is blown, e) some curtains that extend partially covering the front area of the head and f) some lateral plates or sheets that can be flexible, in the form of a bellows or a fan. These previous systems create a semi-independent chamber around the passenger suction zone, where the air is blown a slightly pressurized area is produced. Individually, controls control the air flow and temperature. The air for the seats can be taken from the air conditioning installation on the floor or on the side or roof of the vehicle. The blowing of air from the grooves or hollow arms jets will preferably be carried out in the upper areas of the backrests with filtered and disinfected air.

Air Blown into a Person's Suction Area, with or without a Cover or Hood, Increases the Pressure of the Person, Preventing Contaminated Air from Entering.

Air suction can also be carried out in small compartments made with partitions or curtains, suctioning in each one of them with silent extractors and in the case of aircrafts taking advantage of the external atmospheric depression. The suction can be done through ducts from the floor or the side of the vehicles. Suction will preferably take place in the lower lateral area of the backrest or seat. In the elevators, air extractors are placed in the lower lateral area, adding an air inlet opening in the upper area: Both are protected with grilles.

In restaurants, coffee shops, hospitals, nursing homes and schools, rooms or rooms can be subdivided by partitions, partitions or curtains into small divisions or compartments, applying to each of the compartments obtained the aspiration of air by means of individual silent extractors. This can also be done by applying or introducing a general flow for each room, which can be the air conditioning, and applying an outlet hole in each of the divisions or compartments. In this way, the clients or patients who occupy them become independent and protect each other.

The air conditioning system pressurize and condition the cabin temperature and humidity with the turbofan engines. It is characterized by the fact that for both individual standard and emergency breathing are used:

a) The air conditioning system and its corresponding independent installation,
(b) Some compressors using external air and its corresponding separate installation or
c) The air conditioning system is normally used and the compressors in case of emergency. For this purpose, the air is filtered, disinfected, its pressure, temperature and humidity regulated, and through some ducts it is applied in compartments in the ceiling or in the backrest of the passenger seats, including the cockpit crew areas. In these compartments, the masks, helmets, hoods, their ducts or nasal cannulas are stored, which are directly connected to the air installation, or carries mouthpieces, fittings, quick connector, nozzles sockets, where the ends of the ducts of the masks or portable cannulas are attached. A tongue-and-groove coupling can be made lengthwise, by pressing and overcoming some retainers, with a quarter turn at the end, or by threading or hooking them. This system is valid simultaneously for protection against germs and for breathing in case of emergency.

The masks may be fixed in the compartment or they may be portable and attached to the end of their duct or fitting, tongue and groove or by modifying the flow control knob (51) in the case of current aircrafts.

Compressors are powered by standard electrical power, emergency power or batteries.

Can be used a) Modified current typical ceiling blowing nozzles, (b) Factory-modified air blowing nozzles whose manual knob is shaped divergently outwards or a retainer is applied, or (c) Blowing air nozzles on the seat backrest.

The air conditioning is blown from the bleeding of the turbofan engines, using ducts that take it to the air blowing nozzles in the ceiling or backrest or air is obtained from the outside of the vehicle is blown into the nozzles with compressors.

The current blowing nozzles can be modified adding a retaining ring, a sealing ring, an annular channel, a retaining ring to the manual flow adjustment knobs of the nozzles. They can be modified adding an adapter, with a flange that is fixed to the chassis using screws or an adhesive that allows the tongue and groove connection with the duct end fitting or nasal cannula.

A flared chamber covering the head of a passenger, is connected by a duct to a fitting in the seat backrest. The ducts or nasal cannulas carry the flow regulating valves along. Tooth or teeth embedded on the manual knob, acts as a retainer. An external thread is screwed onto the manual knob, acting as a retainer.

A variant can blow the air through diverging nozzles to widen the application area, slow down and pressurize the area. This can occur through multiple holes or slots in the seat back.

All types of masks can be used, but mainly they must allow the CO2 to escape or otherwise lead it to the outside of the aircraft or vehicle through a conduit.

### BRIEF DESCRIPTION OF THE DRAWINGS

FIG. 1 shows a schematic and perspective view of an aircraft area with a seat which has grooves through which the air is applied or sucked around the passenger aspiration area. Knobs can control the air flow and, where appropriate, the temperature.

FIG. 2 shows a schematic and perspective view of the application of a variant of masks to the passengers of an aircraft.

FIGS. 3, 4 and 5 show schematic and lateral views of the application of variants of the germ protection system using the air provided by the vehicle or by the one supplied with compressors that take it from the outside and filter it. The ends of the ducts carry a quick disconnect fitting with a valve for connection to the air installation. The insulating masks used in FIGS. 4 and 5 do not filter the air, what they do is help to drive air into the respiratory system by isolating it from the vehicle air that may be contaminated. Using the masks of FIGS. 4 and 5 in land vehicles, you can suck the air from outside.

FIG. 5a shows a cross section of an aircraft fuselage and air vents.

FIG. 6 shows a schematic and perspective view of an aircraft area with a spherical or dome-shaped rotating cap on the seat with a passenger.

FIG. 7 shows a schematic and perspective view of an aircraft area with a cover that surrounds the back of a seat, with lateral wings or lugs protruding forward.

FIG. 8 shows a schematic and perspective view of a variant of a way of applying the blowing or suction of air in a seat by means of a duct and a camera in the shape of a diving suit or dome that a traveler carries.

FIG. 9 shows a schematic view of a block diagram of an aircraft air conditioning system applying air to each of the seats.

FIGS. 10, 11, 12 show schematic, plan and partially sectioned views of seat back variants.

FIG. 13 shows a schematic and side view of a portion of the seat of FIG. 12.

FIG. 14 shows a schematic view of a restaurant or cafeteria with spacers between tables.

FIG. 15 shows a schematic and perspective view of the seats of a vehicle with baffles or spacers between the seats.

FIG. 16 shows a schematic and plan view of a vehicle with separating partitions or curtains between seats.

FIG. 17 shows a schematic, sectioned and partial view of a hospital room with the system of the invention.

FIG. 18 shows a schematic, sectioned and partial view of a school room with the system of the invention.

FIG. 19 shows a schematic and plan view of a desk in a central area of the room.

FIG. 20 shows a side view of a passenger using a nasal cannula.

FIG. 21 shows a schematic and perspective view of an individual air nozzle with manual air flow knob.

FIGS. 21a, 21b. 21c, 23a, 23b, and 23c show schematic and perspective views of individual air nozzle variants.

FIGS. 22, 22a, 22b. 22c, 24, 24a, 24b, and 24c show schematic and sectional views of the blower nozzle variants in FIGS. 21, 21a, 21b. 21c, 23, 23a, 23b, and 23c respectively.

FIGS. 25 and 26 show schematic views of insufflation nozzles with clamping variants of an intermediate adapter for the duct or cannula.

FIG. 27 shows a schematic, partially sectioned view of an individual air nozzle manufactured with the manually adjustable deviating flow knob, which allows coupling.

FIGS. 28 and 29 show schematic and perspective views of two blowing nozzle variants with factory modifications.

FIGS. 29a and 30 show schematic and sectional views of two variants of coupling systems between the nozzles and the ducts or nasal cannulas.

FIG. 31 shows a schematic view of a block diagram showing the air conditioning and the application of individual air to passengers from this same air conditioning, of the system of the invention.

FIG. 32 shows a schematic view of a block diagram showing the air conditioning and the application of individual air to passengers, independently fed with outside air through compressors.

FIG. 33 shows a more detailed schematic view of an air conditioning system.

FIG. 34 shows a detailed schematic view of an individual air feeding system using compressors.

FIG. 35 shows a schematic, partially cross sectioned view of a tongue-and-groove connection between the fitting or nozzle and the connector at the end of the mask or nasal cannula. In this case the interconnection can be eliminated by using the end of the mask or cannula tubing attached directly to the fitting in the compartment.

FIG. 36 shows a schematic, partially cross sectioned view of a tongue-and-groove joint between the fitting or compartment nozzle and the connector at the end of the mask tube or a portable nasal cannula.

FIGS. 37 and 38 show perspective views of two types of air-injection nozzles.

FIGS. 37a and 38a show partially cross sectioned views of two types of fitting.

FIGS. 37b and 38b show perspective views of one type of fitting and its exploded view.

FIGS. 39 and 40 show cross sectioned views of two types of duct nozzle connections.

FIG. 41 shows a plant view of an aircraft with the individual air installation.

FIG. 42 shows a schematic, partially sectional view of an individual air nozzle and the application system and mask.

FIG. 43 shows a schematic, partially sectional view of an individual air nozzle and the application of a heating system and a mask.

FIGS. 44, 45 and 46 show schematic and sectional views of air nozzles with variants of the suction cup system.

FIG. 47 shows a schematic view of a passenger with a partial diving suit of the system of the invention.

FIG. 48 shows a schematic view of a passenger with a face mask screen with the system of the invention.

FIG. 49 shows a schematic view of a way to filter the air applied to a mask.

### MORE DETAILED DESCRIPTION OF AN FORM OF EMBODIMENT OF THE INVENTION

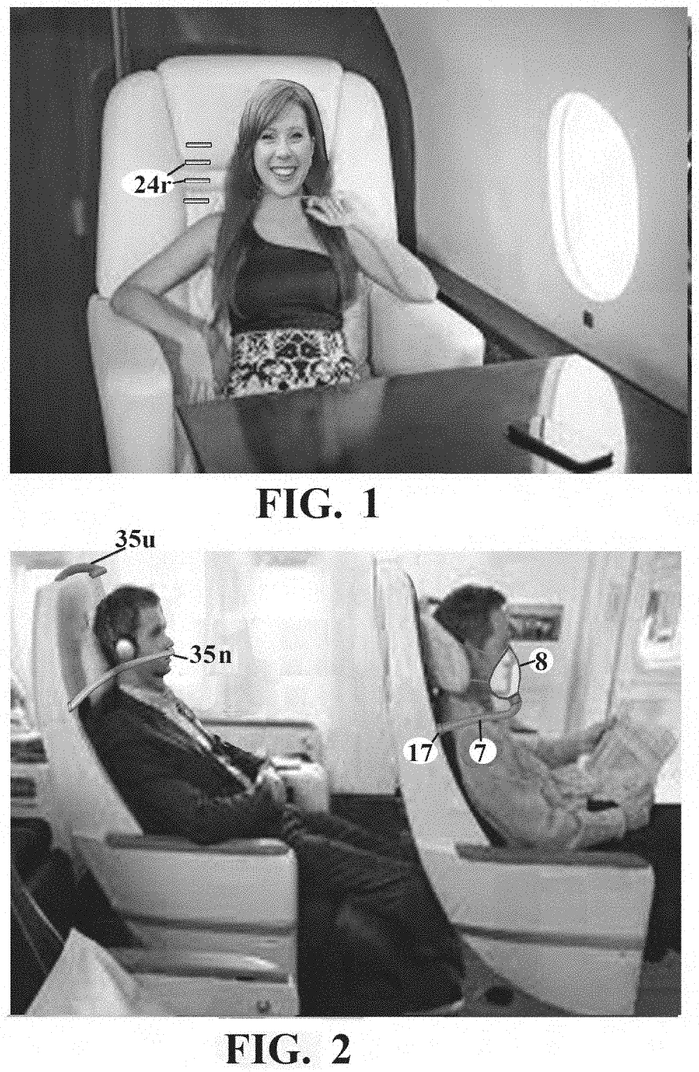

FIG. 1 shows an embodiment of the invention, with a passenger in the seat of an aircraft, whose backrest carries grooves (24r) through which the air discharges and envelops the passenger's breathing zone, who breathes it in. These grooves can alternatively be used in the lower zone to suck the air in that area, thus protecting the rest of the air in the aircraft and consequently the other passengers.

FIG. 2 shows two passengers of an aircraft, one of which receives air through one or more arm jets (35u) in the upper area of the seat back and by a glasses type system (35n) of oxygen that discharges into the nose or in its proximity. The other passenger through the mask (8) sucks the air with the duct (7) that is coupled to the fitting (17) in the backrest. The air is sucked and expelled sending it to the outside of the aircraft, through a valve not shown in the figure. You can use two ducts or a double duct, one for vacuuming and the other for exhaling. Air is received from the aircraft air conditioning system.

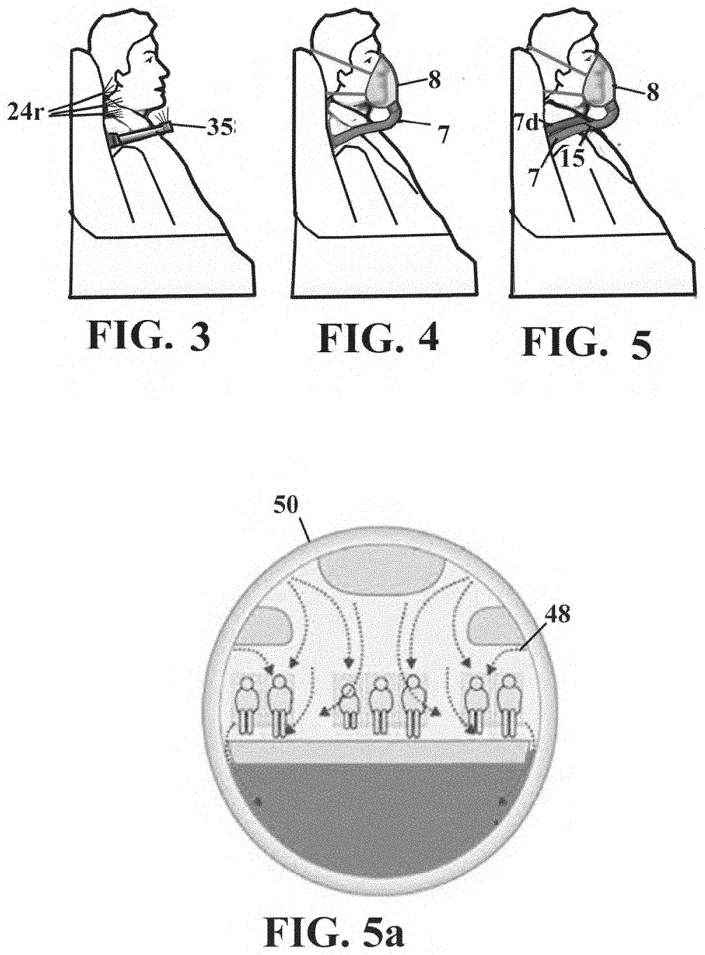

FIG. 3 shows a passenger whose seat carries a rotating, extensible (35) or flexible hollow arm jet which has multiple grooves at its end and others in the backrest (24r) through which air is blown from the aircraft air conditioning or it is sucked and sent abroad.

FIG. 4 shows a passenger who by means of the mask (8), insulating and not filtering, sucks the air through the duct (7) sending it to the exterior of the vehicle in the same way as in FIG. 5, but the valve in this case does not Is in sight. The end of the duct (7) can carry a quick coupling fitting, for attachment to the air installation. The expired air can be directly discharged so that it comes out with the air discarded by the aircraft. In this case the air is sucked in by the low external pressure.

FIG. 5 shows a passenger who, by means of the mask (8), insulating and not filtering, sucks the air through the duct (7) and expels it through the valve (15) through the duct (7d) sending it to the exterior of the vehicle. The ends of the ducts (7 and 7d) can carry a quick coupling fitting, for attachment to the air installation.

FIG. 5a shows the fuselage of the aircraft (50) and the air vents: Including the adjustable vents (48) on the roof and passenger side.

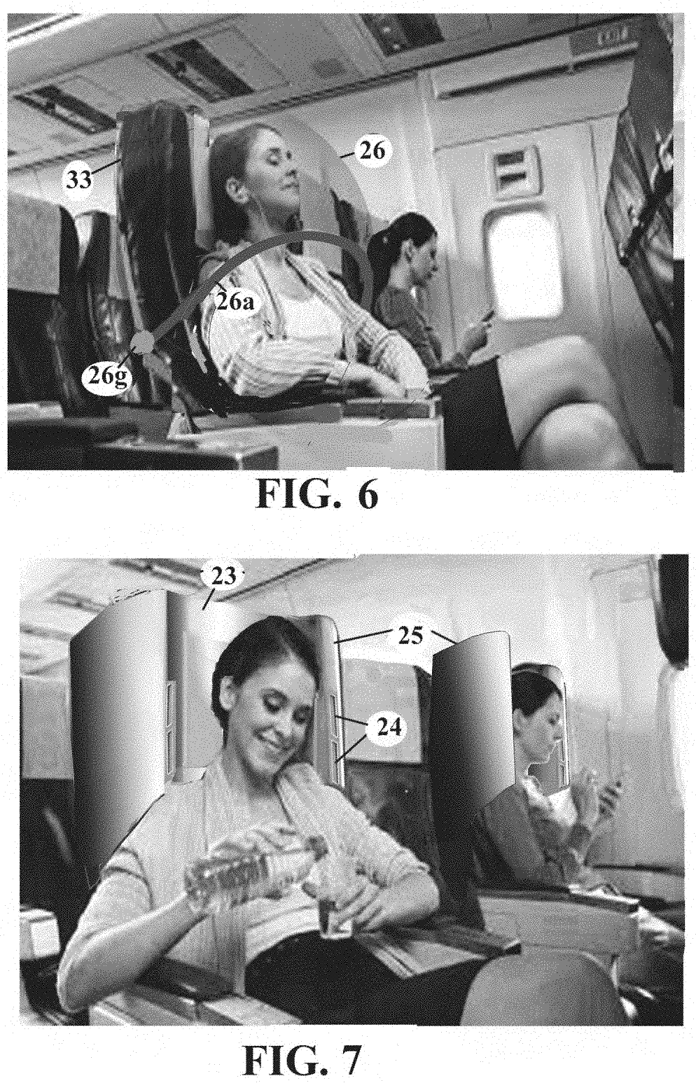

FIG. 6 shows the backrest (33) of a seat, with a rotating cap (26) of plastic sheet material, with the ring portion (26a), rotatable of its ends around the axes (26g). It can also be fixed and attached to the upper part of the backrest. The hood covers the lateral and upper body area. The air outlets or inlets next to the backrest are not shown.

FIG. 7 shows the cap (23) that surrounds the seat back, with the flaps or ears (25) protruding forward, which carry the slots (24) for the exit or entry of air.

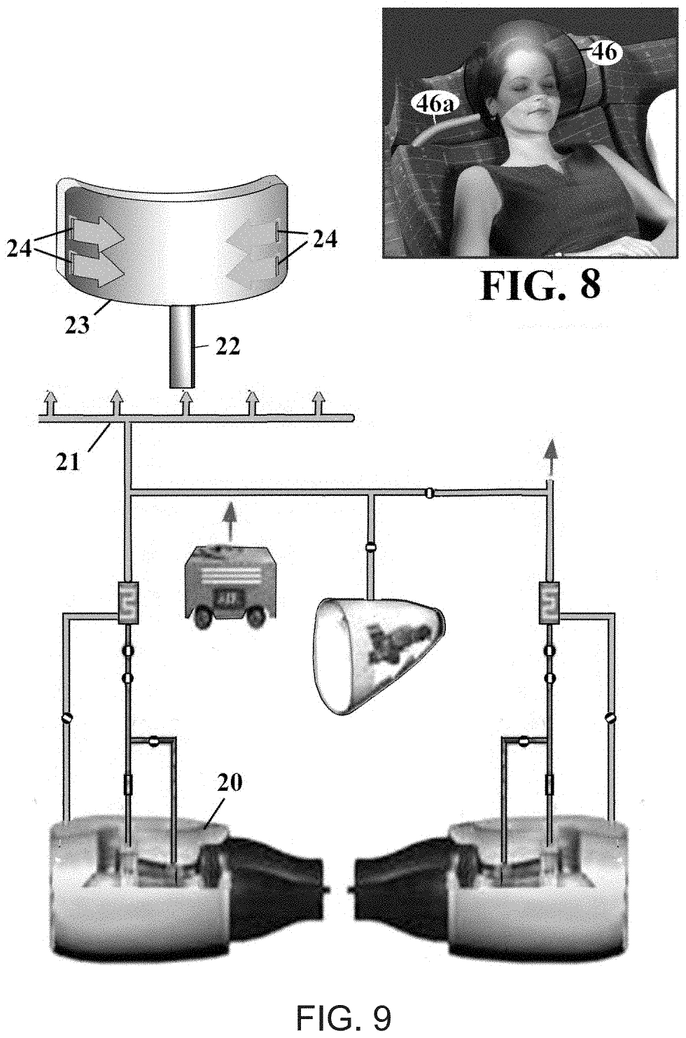

FIG. 8 shows a passenger with a bell-shaped cover (46), flexible, superimposed, transparent and supplied with air through the duct (46a). The duct can also be used to suck in air.

FIG. 9 shows the turbofan engines (20) of an aircraft, the distribution installation of the air conditioning (21) through the ducts (22) to the deflectors (23), which can be the seat backs, exiting through two or more grooves (24), in each of the seats.

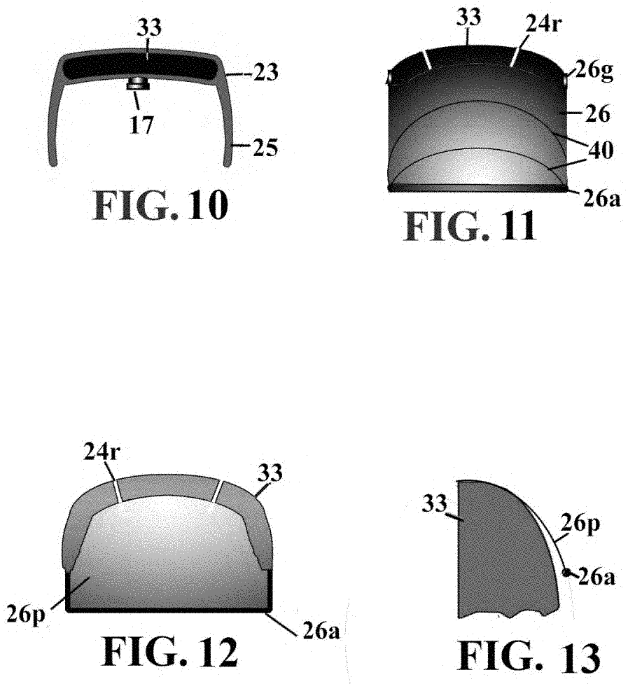

FIG. 10 shows the cap (23) with lateral extensions or lugs (25) that cover and fasten superimposed on the backrest (33) of the seat. It shows the connector (17) where the fitting of the duct of a mask is applied to receive air. The air is discharged through slots, not shown in the figure.

FIG. 11 shows the backrest (33) of a seat, carries a rotating cap (26) of plastic sheet reinforced with the reinforcing arches (40), and the ring portion (26a), the ends of the cap rotate about the axles (26g). The grooves (24r) in the backrest allow the entry or exit of air in the occupied enclosure by the upper passenger area.

FIG. 12 shows the seat back (33), curved with its very forward sides, which provide the housing cover by extending the blind or skirt (26p) by moving the rod or ring forward and down. (26a) that it carries on its front edge. The grooves (24r) in the backrest allow the entry and exit of air in the room occupied by the upper passenger area.

FIG. 13 is a side and partial view of the seat of FIG. 12 shows the seat back (33), the blind or skirt (26p) extended by moving forward and downward the rod or ring (26a) of its front edge.

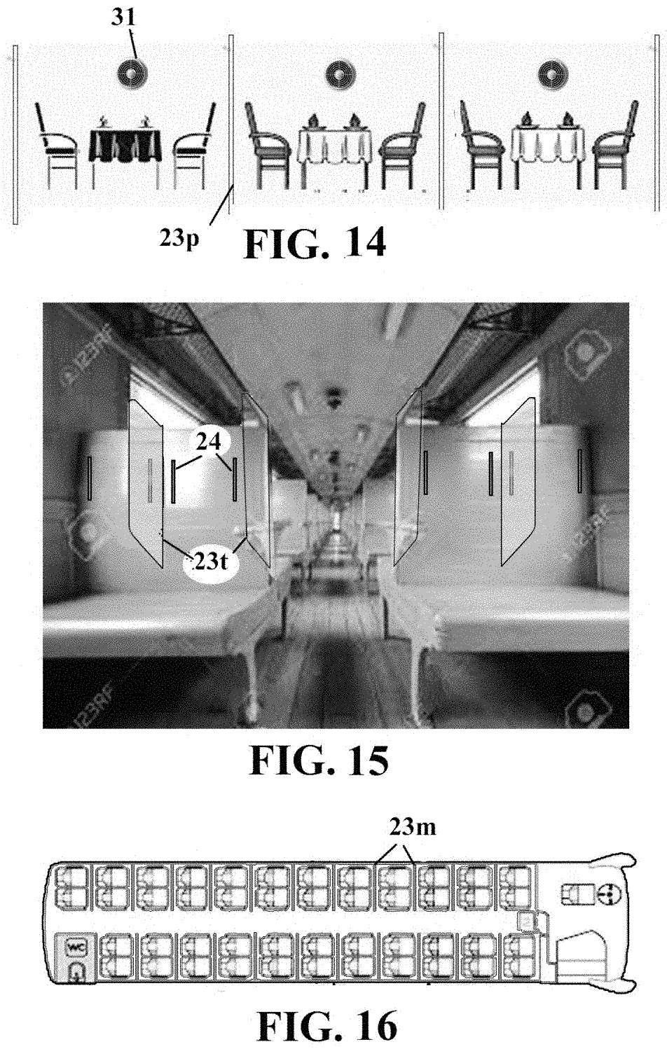

FIG. 14 shows a restaurant or cafeteria with methacrylate partition walls (23) or curtains between the tables, which can be partial or reach the ceiling. Each room has an exhaust fan (31) on the wall. Preferably in the lower area. The central tables can use the system of FIG. 18a.

FIG. 15 shows a vehicle with baffles or spacers (23t) between the seats. Each with the air inlet or outlet slots (24) on the backrest.

FIG. 16 shows a vehicle: bus, plane or train which carries transparent, removable or extensible curtains or transverse partitions (23m) between the seats on each side. You can add other curtains or partitions between each two seats. Curtains and screens can only be partially extended, in low, medium or high area. On the roof, floor or on the side, it has slots for air intake, leaving through the lower seat area or the side of the vehicle. If the air is insufflated or received in each of the enclosures created, the entry of smoke or contaminated air from the enclosures of the other passengers is prevented. Instead of blowing air, it can be sucked out from the outlets in the lower seat or on the side of the vehicle.

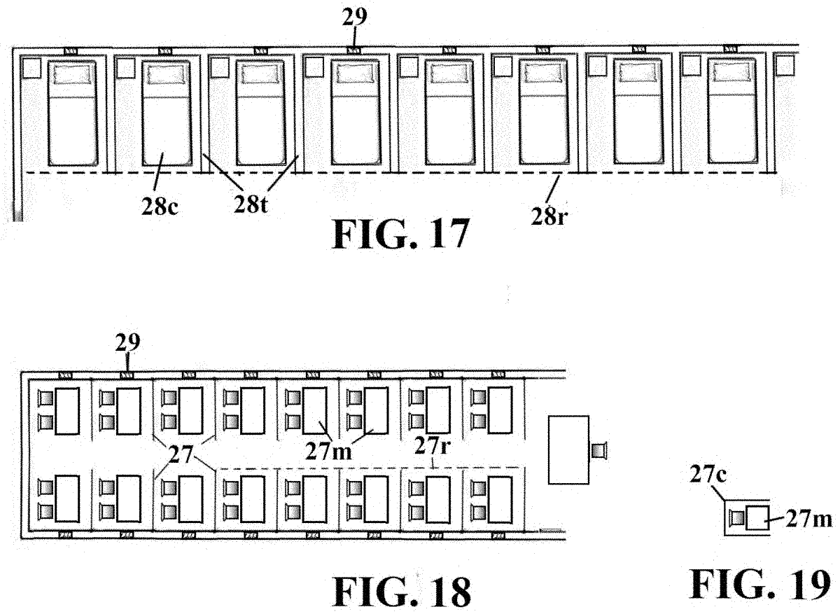

FIG. 17 shows a hospital room divided into some rooms by means of partitions (28t), which can be partitions, with beds (28c), optionally with curtains (28r) and each room with an air extractor (29). The curtains (28r) are extensible or formed by several curtains superimposed laterally. These curtains can carry a transparent area or window, which is closed with a blind or curtain, which allows viewing of the patient from the outside. This system is valid for current rooms and prevents contamination between patients.

FIG. 18 shows a school room divided into some rooms by means of partitions (27) or medium-height partitions, for each table (27m): Each room has an air extractor (29). You can add the optional curtain (27r) also half height.

FIG. 19 shows the table or desk (27m) partially surrounded by the U-shaped screen or curtain (27c). The exhaust fan is on the floor, not shown in the figure.

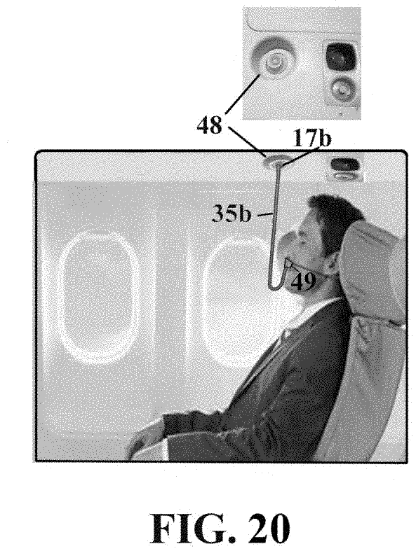

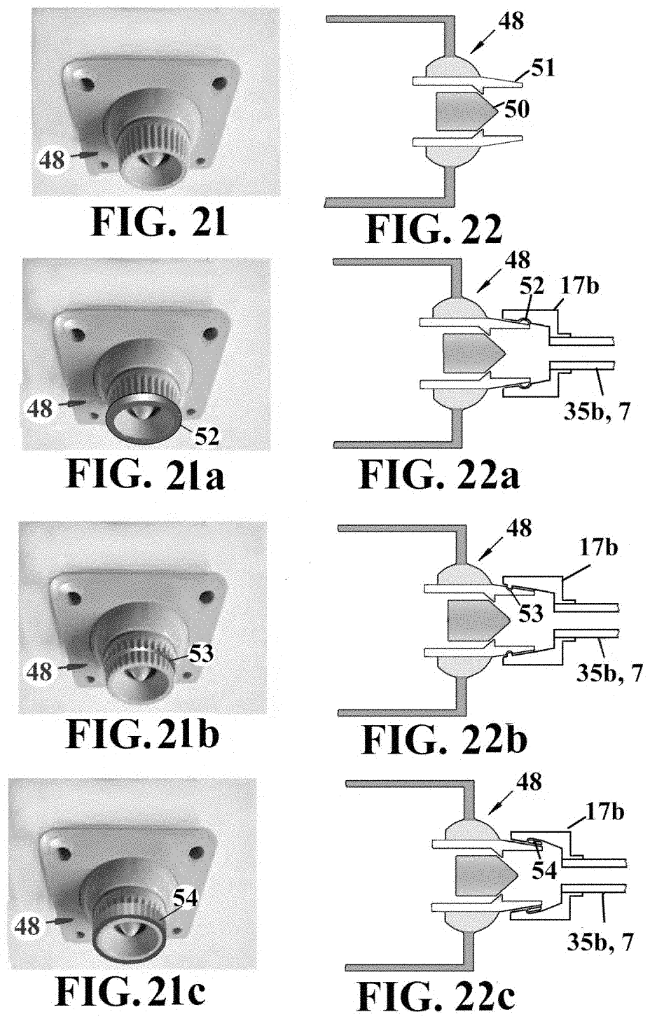

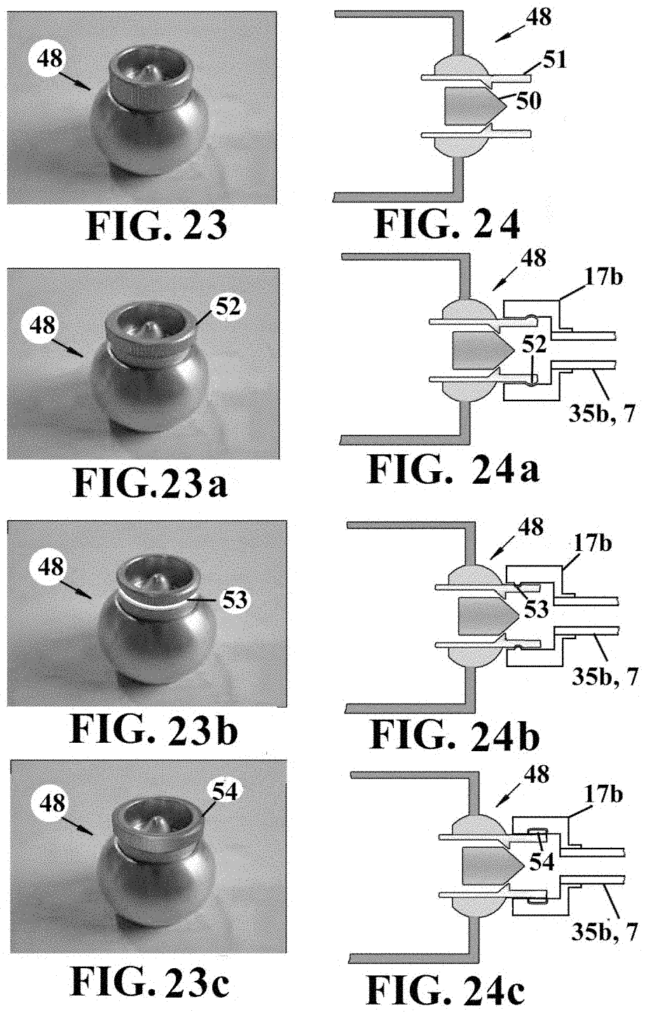

FIG. 20 shows the air jet or flowing nozzle (48) to whose nozzle or manual flow adjuster (51) an annular channel is applied, rings that act as retainers are adhered to it, or a coupling by means of rapid pressure tongue and groove or a thread with the fitting or connector (17b) at the end of the nasal cannula (35b), which fits in this case on the nose and mouth with the external cover or screen (49). These can be replaced by a mask.

FIG. 21 shows a current typical blowing nozzle (48).

FIG. 22 shows the air nozzle (38) in FIG. 1, conical air flow restrictor (50) and manual air adjustment knob (51), can be considered as a form of implementation.

FIG. 21a shows a current blowing air nozzle (48), to which manual adjusting knob the retaining ring (52) is added.

FIG. 22a shows a current blowing air nozzle (48), to whose manual adjusting air knob the retaining ring (52) is added, where the fitting (17b) is joint by means of a tongue and groove at the end of the duct or cannula (35b, 7).

FIG. 21b shows a current blowing air nozzle (48), to which manual adjusting air knob is added at least one ring channel (53) that act like retainers.

FIG. 22b shows a current blowing air nozzle (48), to which manual adjusting air knob the annular channel (53) that act like a retainer, where the fitting (17b) is tightened by means of a tongue and groove at the end of the duct or cannula (35b, 7).

FIG. 21c shows a current blowing air nozzle (48), to which the ring (54) is added by gluing, that acts as a retainer.

FIG. 22c shows a current blowing air nozzle (48), to which the ring (54) is added by gluing, that acts as a retainer, where the fitting (17b) is joint by means of a tongue-and-groove joint at the end of the duct or cannula (35b, 7).

FIG. 23 shows a current blowing air nozzle (48).

FIG. 24 shows the current blowing air nozzle (38) of FIG. 23, the conical air flow restrictor (50) and the manual air adjusting knob (51).

FIG. 23a shows a current blowing air nozzle (48), to which manual adjusting knob is added the retaining ring (52).

FIG. 24a shows a current blowing air nozzle (48), to which manual adjusting air knob the retaining ring (52) is added, where the fitting (17b) is joint by means of a tongue and groove at the end of the duct or cannula (35b, 7).

FIG. 23b shows a current blowing air nozzle (48), to which manual adjusting air knob is added at least one ring channel (53) that act like retainers.

FIG. 24b shows a typical existing insufflation nozzle (48), with the manual air adjustment knob supplemented by the annular gap (53) acting as a retainer, where the fitting (17b) at the end of the duct or cannula (35b, 7) is tightened by means of a tongue and groove.

The FIG. 23c shows a current blowing air nozzle (48), to which the ring (54) is added by gluing, that acts as a retainer.

FIG. 24c shows a current blowing air nozzle (48), to which the ring (54) is added by gluing, that acts as a retainer, where the fitting (17b) is joint by means of a tongue-and-groove joint at the end of the duct or cannula (35b, 7).

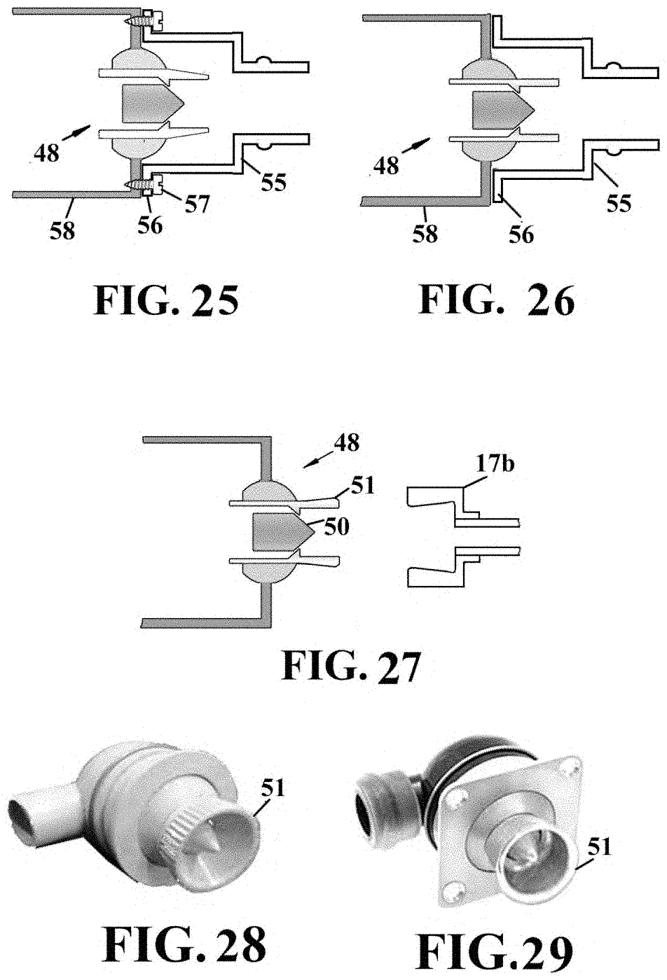

FIG. 25 shows a current blowing air nozzle (48) to which the adapter (55) is added, which carries a flange (56) which is attached to the chassis (58) by means of the screws (57).

The intermediate adapter (55) allows tongue-and-groove connection with the duct end fitting or nasal cannula.

FIG. 26 shows a blowing air nozzle (48) to which the adapter (55) is added, which carries a flange (56) that is attached to the chassis (58) by means of an adhesive. The intermediate adapter (55) allows tongue-and-groove connection with the duct end fitting or nasal cannula. In one variant the flange used here is applied to the end of the duct or nasal cannula by gluing instead of tongue-and-groove.

FIG. 27 shows a new blowing nozzle (48) and the conical airflow restrictor (50). The manual air adjustment knob (51) is shaped divergently towards the outside, to be tongue-and-groove with the fitting (17b), at the end of the duct or cannula. It admits other types of seals as used in FIGS. 2a, 2b and 2c.

FIG. 28 is the blowing nozzle manufactured with the manual control (51) that regulates the air flow and adopts a divergent shape to facilitate the tongue-and-groove joint with the fitting at the end of the duct or nasal cannula.

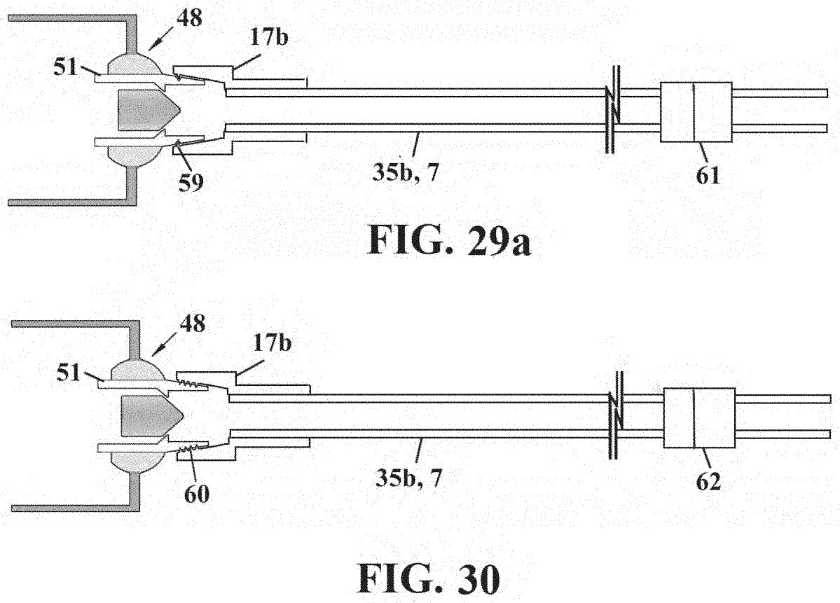

FIG. 29 is the blowing nozzle manufactured with the manual control (51) which regulates the air flow and is shaped divergently to facilitate the tongue-and-groove jointing with the duct end fitting or nasal cannula FIG. 29a shows a typical current blowing nozzle (48), where the tongue and groove connector or fitting (17b) at the end of the duct or cannula (35b, 7), carries a tooth or teeth (59) which are embedded on the manual control (51), acting as a retainer. This can be replaced by an adapter such as the one (55) in FIGS. 5 and 6. Add the flow regulating valve (61).

FIG. 30 shows a typical current blowing nozzle (48), where the tongue and groove connector (17b) at the end of the duct or cannula (35b, 7), by means of the internal thread (60), is threaded onto the manual knob (51), acting as a retainer. This can be replaced by an adapter such as the one (55) in FIGS. 5 and 6. Add the sliding interconnection (62), which allows the two sections of the duct into which it is divided to slide.

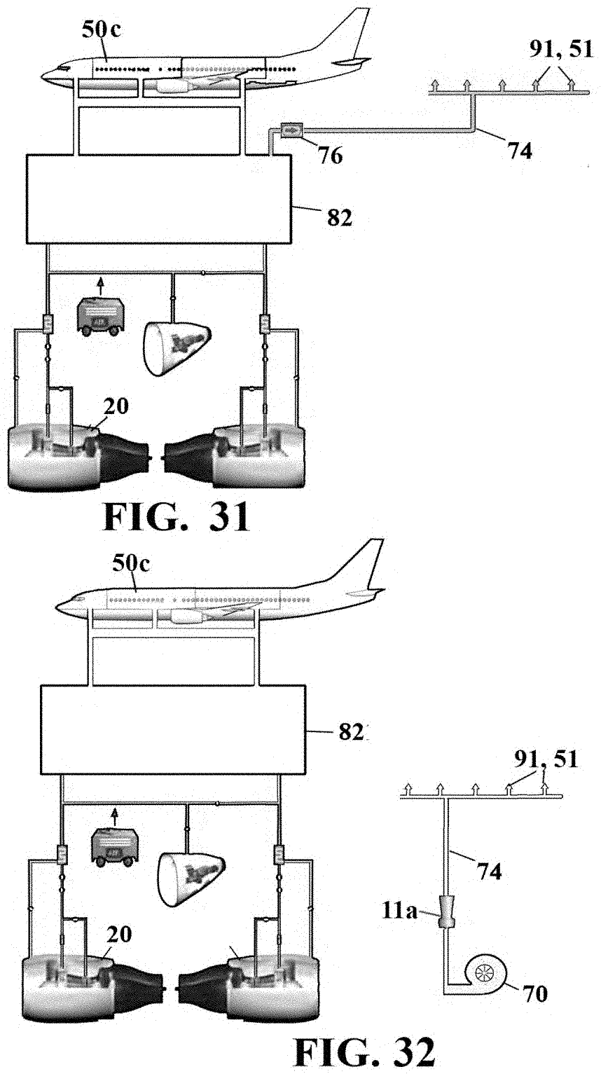

FIG. 31 shows the turbofan engines (20) which supply pressurised air to the air conditioning system (82) and from this the air is applied to the aircraft cabin (50c) to pressurise it and maintain the humidity and temperature. It also supplies through the ducts (74) and through the check valves (76), to the individual mouthpieces, fittings, quick connections or nozzles sockets (91) and from nozzles or flow knobs (51) for coupling masks or fixed masks, in the compartment at each passenger's position.

FIG. 32 shows the turbofan engines (20) which feed pressurised air to the air conditioning system (82) and from this, the air is applied to the aircraft cabin (50c) to pressurise it and maintain temperature and humidity. In this case the compressors (70) take the air from the outside and apply it through the ducts (74) to the individual mouthpieces, fittings, quick connections or nozzles sockets (91) and nozzles (51) for coupling the masks, in the compartment at each passenger's position.

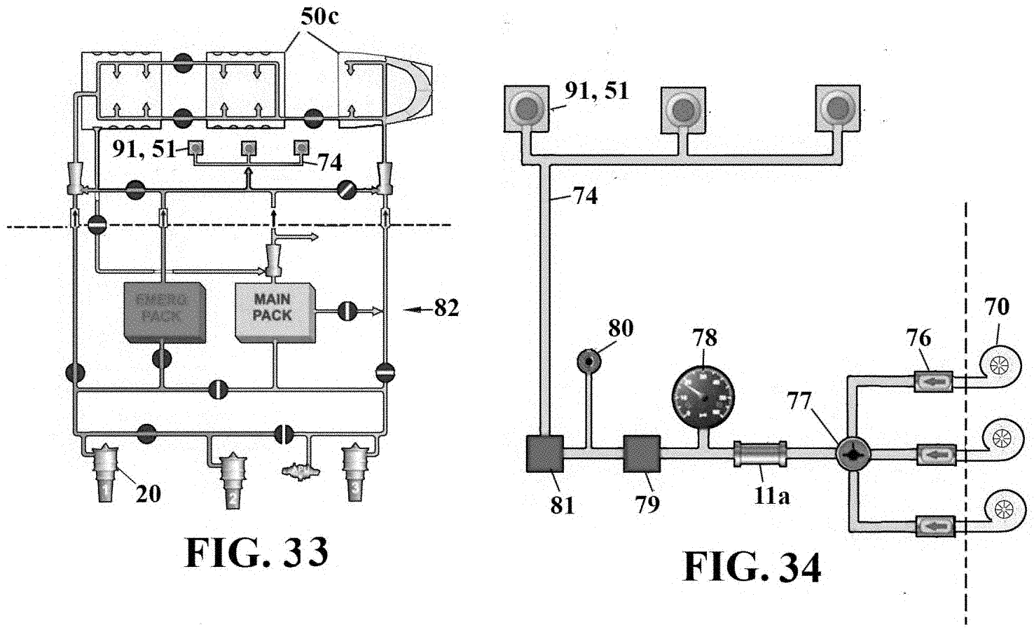

FIG. 33 shows the turbofan engines (20) feeding pressurised air to the air conditioning system (82) and from this the air is applied to the aircraft cabin (50c) to pressurise it and regulate the temperature. It also feeds the individual mouthpieces, fittings, quick connections or nozzles sockets (91) and the nozzles or flow knobs (51) for mask coupling or fixed masks, in the compartment at each passenger's position

FIG. 34 shows the compressors (70), sending air into the aircraft through check valves (76) to a selector valve (77), and then to the filter (11a), temperature gauge (78) and temperature regulator (79), then to a relief valve (80) and flow regulator (81) and via the duct (74) to the individual mouthpieces, fittings, quick connections or nozzles sockets (91) and nozzles or flow knobs (51) for masks coupling or fixed masks, in the compartment at each passenger's position.

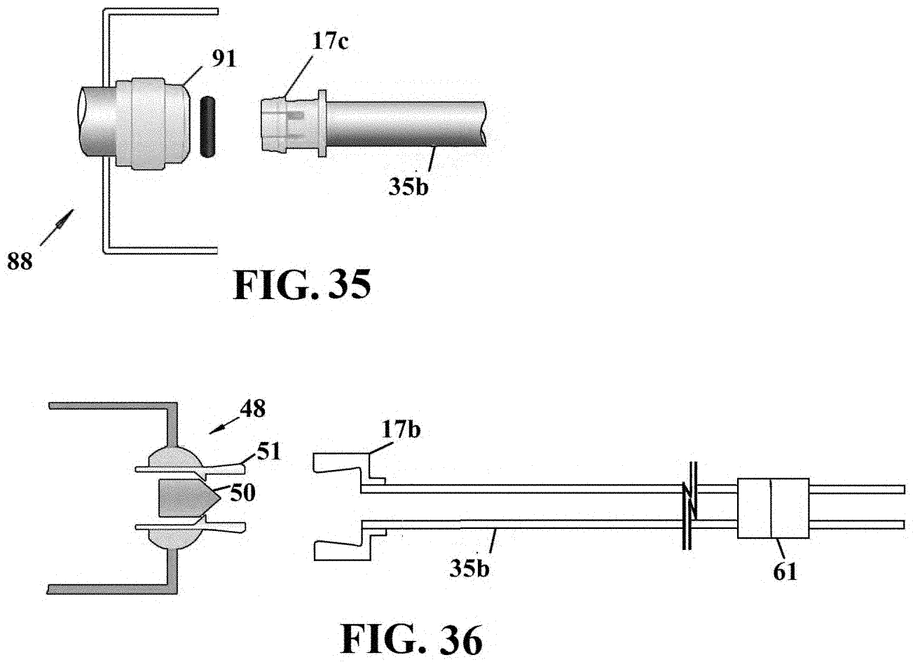

FIG. 35 shows the compartment (88) in the ceiling or backrest of a passenger seat. It carries the individual mouthpieces, fittings, quick connections or nozzles sockets (91) where it is fitted by tongue and groove to the fitting (17c) at the end of the duct (35b) of the mask or nasal cannula.

FIG. 36 shows the air-injection nozzle (48), with the flow restrictor (50), and the manual flow adjustment knob (51) on which it can be tongue-and-groove with the fitting (17b) at the end of the duct (35b), of the mask or nasal cannula. At the end, next to the mask, there is a flow control knob (61) which can also be used to turn the two sections of the tube.

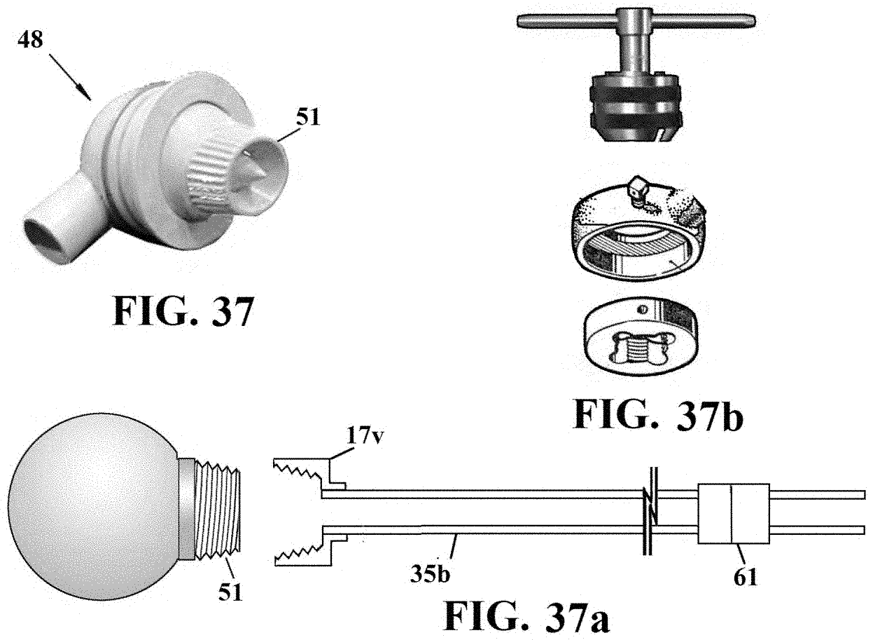

FIG. 37 shows the air-injection nozzle (48) with the flow control (51) in a frustoconical shape,

FIG. 37a shows the duct or cannula (35b) with the flow regulator (61). Its other end carries the internally threaded fitting (17v), which is threaded onto the flow regulator knob (51) threaded with the tap in FIG. 37b. They are connected by means of threading.

FIG. 37b shows the tap used to thread the frustoconical flow control knob (51).

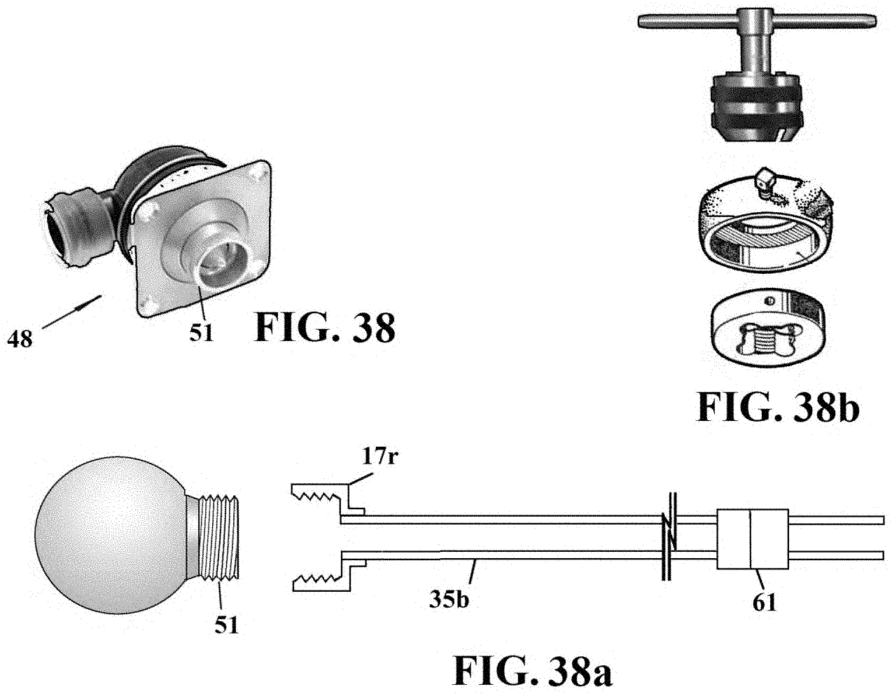

FIG. 38 shows the air-injection nozzle (48) with the cylindrical flow knob (51).

FIG. 38a shows the duct or cannula (35b) with the flow control (61). Its internally threaded end (17r), which is threaded onto the flow control knob (51) with the tap in FIG. 38b. They are connected by means of this thread.

FIG. 38b shows the tap used to thread the cylindrical flow control knob (51).

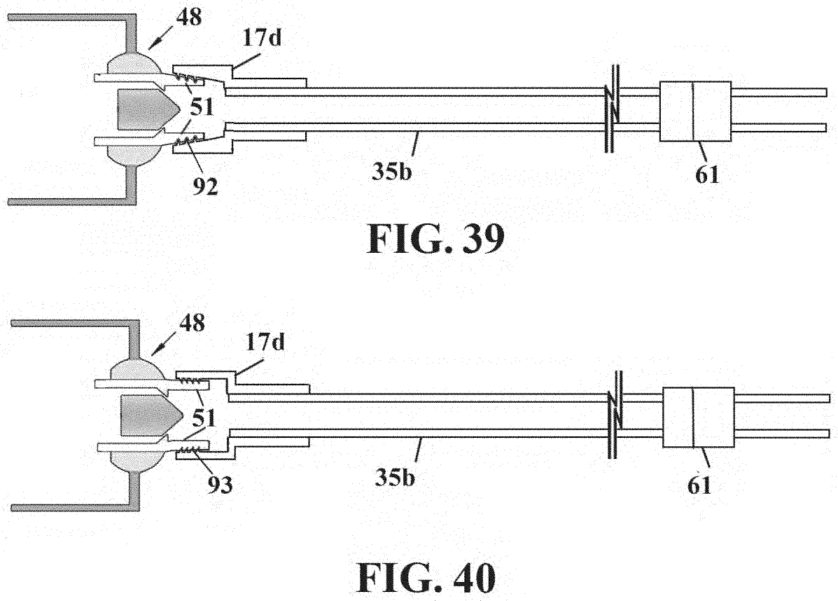

FIG. 39 shows the duct or cannula (35b) with the flow regulator (61). Its end (17d) carries saw teeth (92), which, after being pressed, lock and clip onto the plastic tapered flow control knob (51), which is part of the air supply nozzle (48).

FIG. 40 shows the duct or cannula (35b) with the flow regulator (61). Its end (17d) is internally threaded (93), which are threaded with the external thread of the flow control knob (51), cylindrical type, which is part of the air nozzle (48). This thread is more typical of metal knobs (51).

With both of the above systems, no modifications need to be made to the aircraft.

FIG. 41 shows the aircraft (50), the air compressors (70) that get the air from outside, compresses and filters it through microparticle or nanoparticle filters (71) and sends it to the air conditioning system along with the air (73) coming from the turbofan engines (72). You can use both systems or just the compressor system. It is shown the individual line installation (74) that provide air through the individual mouthpieces, fittings, quick connections or nozzles sockets (91).

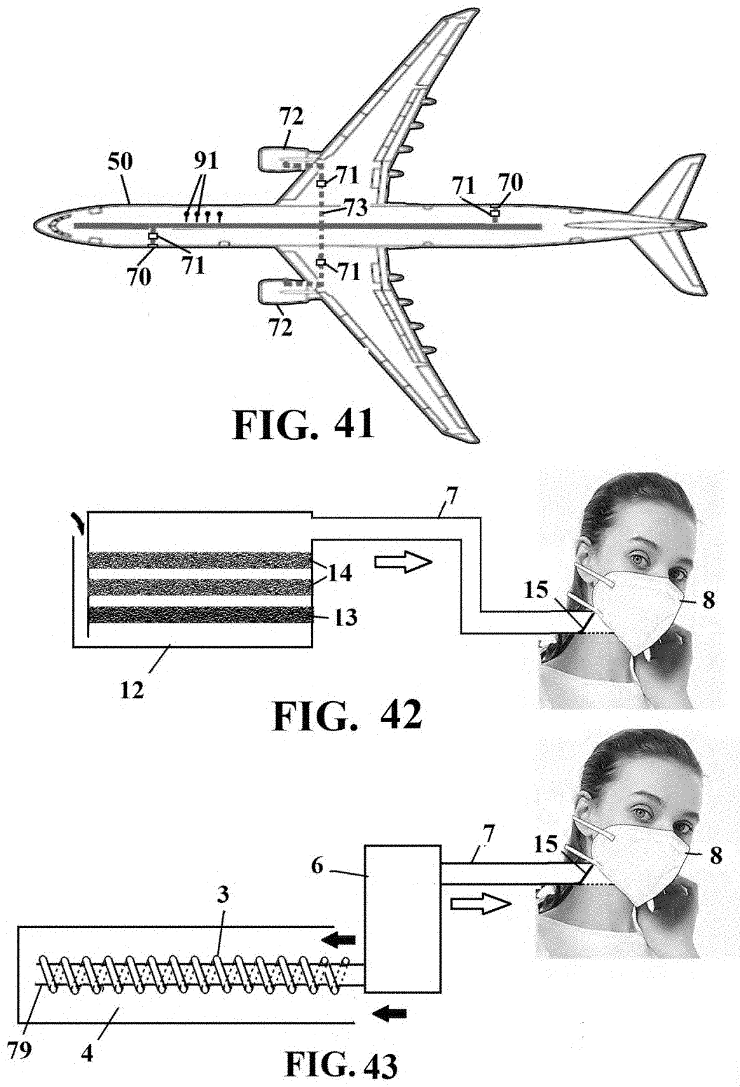

FIG. 42 shows the chamber (12) inside which pads (14) formed by microfilaments impregnated or soaked with a disinfecting and/or adherent liquid, one of them with activated carbon (13), are superimposed. The microparticles that the aspirated air carries adhere to the microfilaments, the purified air passing through the duct (7) and the valve (15) to the mask (8). These pads without the chamber can be applied to the inside of the mask. The chamber (12) can have only a liquid to filter the air. The air is sucked through the pads or liquid.

FIG. 43 shows inside the chamber (4) the duct (79) surrounded by the heating resistor (3), and through which the air heated between 55 and 90° C. passes to the cooling chamber (6) and from here through the duct (7) and the valve (15) that opens during aspiration to the mask (8). The heating resistor can be replaced by an ultraviolet lightning lamp.

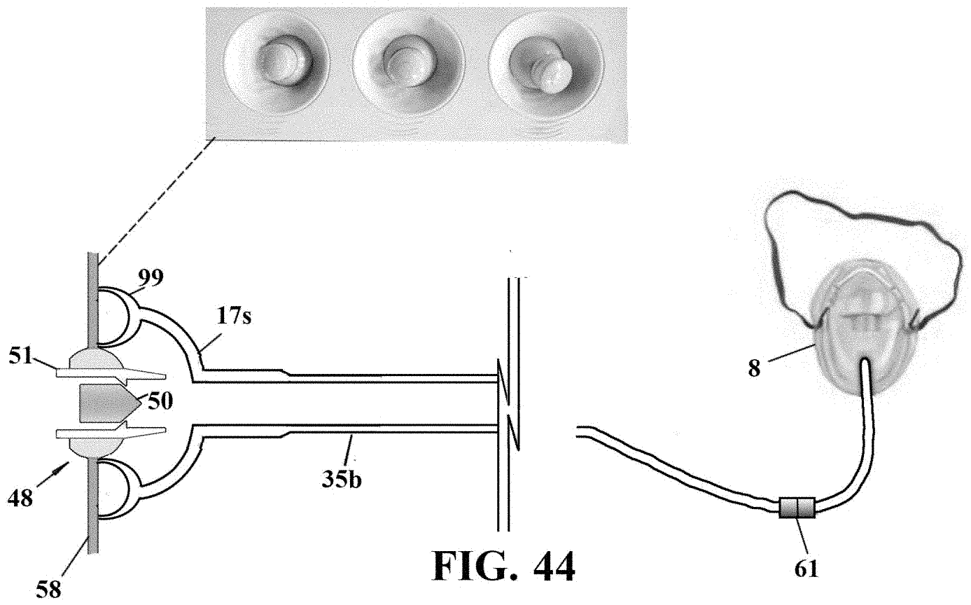

FIG. 44 shows a typical current nozzle (48) with the manual air flow adjustment knob (51), the conical flow restrictor (50). The mask (8) carries at the end of its duct (35b), the bell (17s), which has the semi-annular or semi-toroidal suction cup (99), which surrounds the blowing nozzle (48) and when pressed against the surface of the chassis or panel (58) remains attached and fixed for use. In this case the surface of the chassis is flat. Add air flow regulator (61). The bell can cover several air nozzles, in this case the bell carries the ducts for several masks, screens, etc.

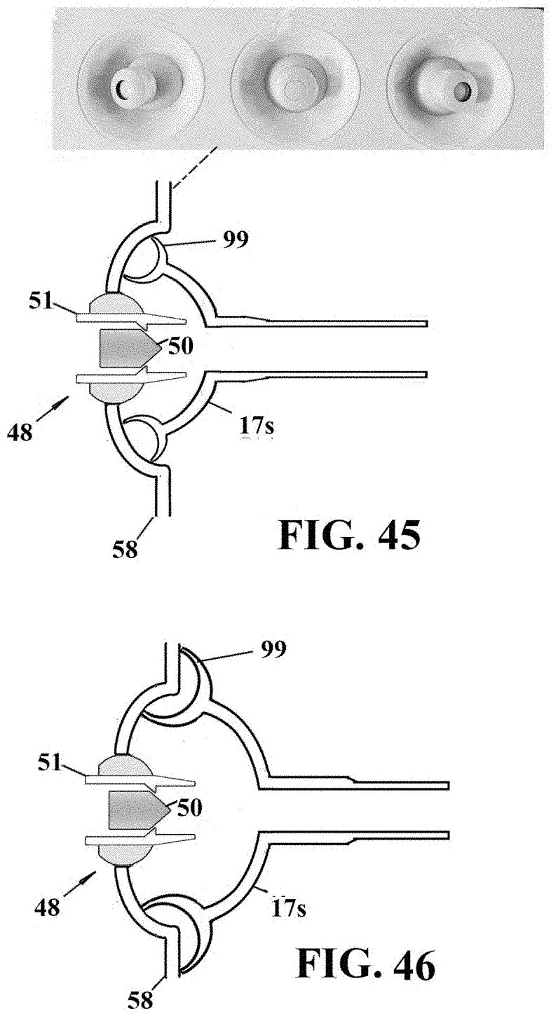

FIG. 45 shows a typical current blower nozzle (48) with the manual air flow adjustment knob (51), the conical flow restrictor (50). The end of the mask duct with the bell (17s), which carries the semi-annular or semi-toroidal suction cup (99), which once pressed into the concave surface of the frame or panel (58), remains attached and fixed for use.

FIG. 46 shows a typical current blower nozzle (48) with the manual air flow adjustment knob (51), the conical flow restrictor (50). The end of the mask duct with the bell (17s), which carries the semi-annular or semi-toroidal suction cup (99), which once pressed on the protruding edge between the concave surface of the frame or panel (58) and the flat surface of the frame, is adapted, attached and secured for use.

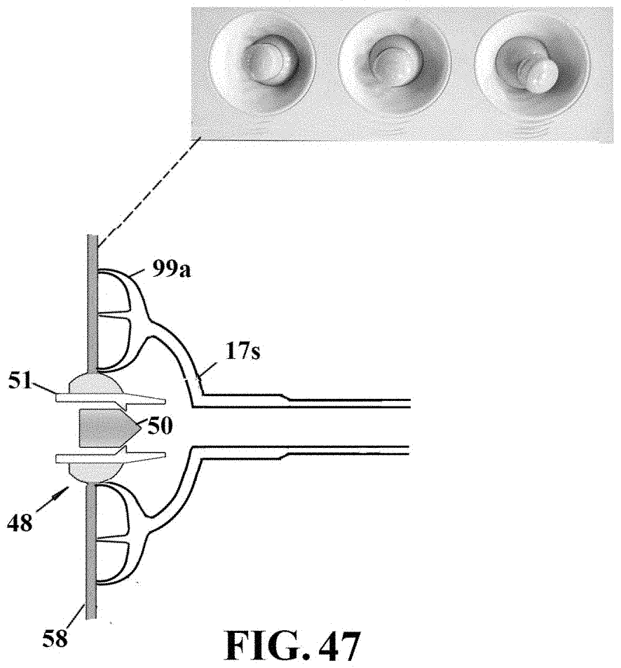

FIG. 47 shows a typical current blower nozzle (48) with the manual air flow adjustment knob (51), the conical flow restrictor (50). The end of the mask duct carries the bell (17s), which carries the two semi-annular or semi-toroidal suction cups (99a), which surround the blowing nozzle (48) and when pressed against the surface of the frame or panel (58), are adapted, attached and held in place for use. In this case the surface of the chassis is flat. The use of several suction cups allows a better adaptation in case of irregularities on the surface of the chassis.

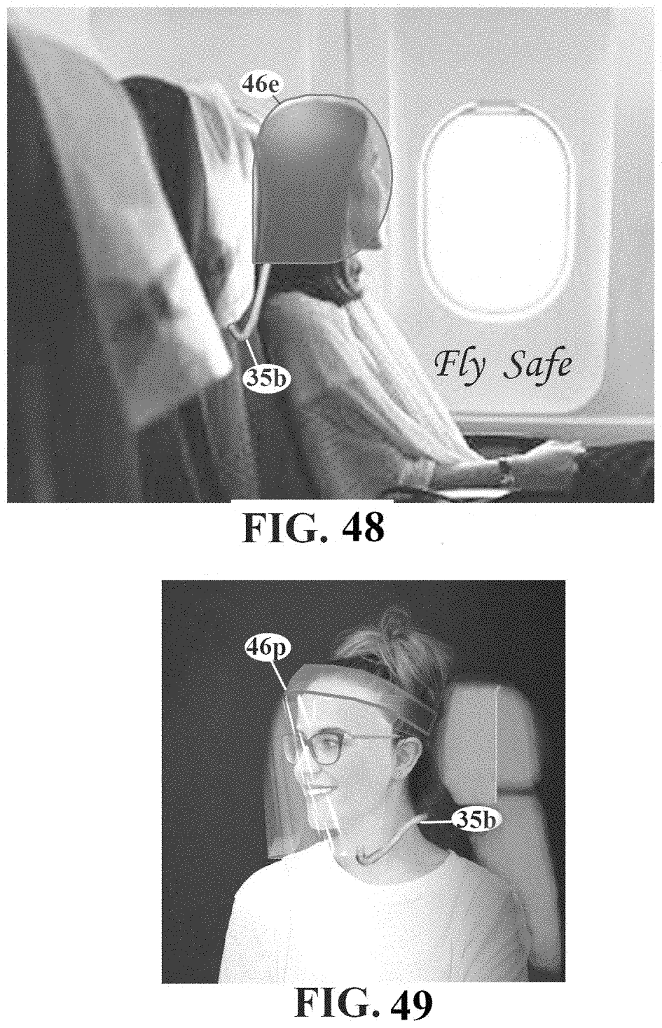

FIG. 48 shows the air-fed partial dome (46e) through the duct (35b) connected to the seat back panel.

FIG. 49 shows the air-filled display (46p) fed internally by the duct (35b) connected to the seat back panel. The duct can be attached to the top reinforcing edge of the screen.

1. Germ protection system for vehicles, hospitals, restaurants, schools, nursing homes, lifts and the like, using:
a) A system that prevents germs: bacteria, protozoa, viruses or parasites from being breathed in vehicles or closed premises, lifts or the like, blowing or sucking air,
b) In restaurants, coffee shops, hospitals, nursing homes and schools or rooms are subdivided by partitions or curtains into small divisions or compartments, where are applied pressure o suction and in the case of aircrafts taking advantage of the external atmospheric depression.
c) An independent air installation that applies air conditioning, fed with turbofan engines or extracts and compress external air, to the individual air blowing nozzles in the ceiling or backrest of the compartments of each passenger,
d) An independent air installation that extracts and compresses the outside air, and apply it to the individual air blowing nozzles in the ceiling or backrest of the compartments of each passenger,
e) A system that uses an independent individual installation to replace oxygen system in case of emergency, the air is filtered, disinfected. Its pressure, temperature and humidity regulated, and through some ducts it is applied in the compartments, the masks, helmets, hoods, their ducts or nasal cannulas are stored, which are directly connected to the air installation, or carries mouthpieces, fittings, quick connector, nozzles sockets, where the ends of the ducts of the masks or portable cannulas are attached and
f) A system that is coupled to the individual air supply nozzle of the passengers, using for this purpose at the end of the duct of the mask, face mask screen, diving suit or helmet, a hood with at least one semi-annular, semi-toroidal or semi-oval suction cup which, when pressed, adapts and attaches to the chassis or panel carrying the air supply nozzles (48) of the air conditioning system of the aircraft or vehicle.

2. System according to claim 1, wherein the air is blown or sucked in the upper middle area of the back of the seats through grooves.

3. System according to claim 1, wherein the air is blown with some arms jets or nasal cannulas such as oxygen, (7, 35, 35n, 35b and 46a), which apply it to the nose, mask or hood, whose ends are tongue and groove with the manual flow nozzle or adjuster (51), for this an annular channel is applied, a ring that acts as a retainer is attached, or a quick coupling under pressure or thread with the fitting or connector (17b) to the ceiling air blowing nozzle (48), or to the fitting (17), giving them a domed, flared or threaded shape, optionally adding a glued intermediate adapter.

4. System according to claim 1, wherein the air is blown or applied to the mouth and nose by an insulating mask, through a duct attached to the backrest or to the existing air jet over the passenger's head.

5. System according to claim 1, wherein in vehicles and especially in aircrafts, air jets are applied to the passenger from grooves, additional ducts or tubes or a rotating hollow arm jet that insufflates the air in the area of the seat backrest close to the head.

6. System according to claim 1, wherein is used a flared chamber or flared cover next to the head at the back of the seat, connected by a duct to a fitting in the seat backrest.

7. System according to claim 1, wherein is used a dome-shaped cap that covers and fasten simultaneously the backrest and part of the head area.

8. System according to claim 1, wherein in the restaurants, coffee rooms, hospitals, nursing homes and schools, the rooms are subdivided by partitions, screens or curtains in small divisions or compartments, applying to each of the compartments obtained the air aspiration using individual silent extractors.

9. System according to claim 1, wherein in the restaurants, coffee shops, hospitals, nursing homes and schools, the rooms are subdivided by means of partitions, screens or curtains in small divisions or compartments, applying the air that comes from the air conditioning, and exits through an air outlet hole in each of said compartments.

10. System according to claim 1, wherein in the restaurants, coffee shops, hospitals, residences and schools the rooms are subdivided by means of partitions, screens or curtains in small divisions or compartments, applying air extractors to each of these compartments.

11. System according to claim 3, wherein the masks are portable or disposable and use a conduit with a quick coupling fitting on the backs of the vehicles and the expired air through a duct by means of a valve is sent outside.

12. System according to claim 1, wherein air extractors are placed in the lower lateral area of the lifts, adding an air inlet opening in the upper area, and both protected with grilles.

13. A system according to claim 1, wherein a mask or a nasal cannula is added, connected by a duct to an air inlet in the seat backrest, said duct having flow regulating valves along and a duct that allows for relative rotation between them.

14. System according to claim 1, wherein in the compartments are kept masks, helmets, hoods, their ducts or nasal cannulas, which are directly attached to the air installation.

15. System according to claim 1, wherein the compartments carry the individual mouthpieces, fittings, quick connections or nozzles sockets, where the ends of the ducts of the masks or portable cannulas are joined by a tongue-and-groove joint, for this, the current regulating controls are modified with rings, channels or flares that act as a retainer.

16. System according to claim 1, wherein the air of the compressors is filtered, the temperature, humidity and pressure are regulated, and is controlled by means of the installation, check valves, selector and relief valves, filters and pressure indicators and are powered by normal, emergency or battery energy.

17. System according to claim 3, wherein the nozzles blow the air through divergent nozzles to expand the application area, reduce speed and pressurize the area around the head.

18. System according to claim 1, wherein the suction cups, once pressed, adapt, adhere and fasten to the flat or concave surface of the chassis or carrier panel around one or several nozzles, in this last case the hood carries the ducts for several masks, screens or diving suits.

19. System according to claim 1, wherein inside a chamber (4) the duct (79) surrounded by the heating resistor (3), and through which the air heated between 55 and 90° C. passes to the cooling chamber (6) and from here through the duct (7) and the valve (15) that opens during aspiration to the mask (8), the heating resistor can be replaced by an ultraviolet lightning lamp.

20. System according to claim 1, wherein the breathing air is sucked through a chamber (12) with a liquid or superimposed pads (14) formed by microfilaments impregnated or soaked with a disinfecting and/or adherent liquid, one of them with activated carbon (13), optionally this pads can be applied to the inside of a mask.
